(19) United States
(12) Patent Application Publication
(10) Pub. No.: US 2015/0252919 A1
(43) Pub. Date: Sep. 10, 2015

(54) PROCESS FOR MARKING ARMOR CABLE AND PRODUCT

(71) Applicants: Paul McMillen, Bolton (CA); Marc Fitzner, Mississauga (CA)

(72) Inventors: Paul McMillen, Bolton (CA); Marc Fitzner, Mississauga (CA)

(21) Appl. No.: 14/641,650

(22) Filed: Mar. 9, 2015

Related U.S. Application Data
(60) Provisional application No. 61/949,323, filed on Mar. 7, 2014.

(51) Int. Cl. F16L 11/12

(52) U.S. Cl. CPC F16L 11/124

(57) ABSTRACT

The product is of the type having a metal strip encircling a central longitudinal axis in a coiling manner, the strip defining a tubular arrangement, the tubular arrangement having a groove defined by the edges of the strip. The improvement in the product comprises: a yarn secured to the tubular arrangement, encircling the central longitudinal axis in a coiling manner and occupying the groove. The process is for use with a product, to product being of the type having a metal strip encircling a central longitudinal axis in a coiling manner, the strip defining a tubular arrangement, the tubular arrangement having a groove defined by the edges of the strip. The process comprises the steps of: coiling a yarn about the tubular arrangement such that the yarn encircles the central longitudinal axis in a coiling manner and occupies the groove, thereby to produce a marked product.

### CROSS-REFERENCE TO RELATED APPLICATIONS

This application claims the benefit of U.S. Provisional Application No. 61/949,323 filed Mar. 7, 2014, which is incorporated herein by reference.

### FIELD OF THE INVENTION

The invention relates to the field of flexible conduit and armored cable.

### BACKGROUND OF THE INVENTION

It is known to paint the surface of armored cable, to allow for the identification thereof. It is also known to paint the strip of metal used to form the armored cable. Both processes are relatively expensive.

### SUMMARY OF THE INVENTION

Forming one aspect of the invention is an improved product. The product is of the type having a metal strip encircling a central longitudinal axis in a coiling manner. The strip defines a tubular arrangement. The tubular arrangement has a groove defined by the edges of the strip. The improvement comprises a yarn secured to the tubular arrangement, encircling the central longitudinal axis in a coiling manner and occupying the groove.

According to another aspect, in the product, the appearance of the yarn can change in a repeat pattern along its length such that the yarn appears as strips of changing appearance arranged in a repeating pattern along the length of the tubular arrangement.

According to another aspect, the yarn can be adhesively secured to the tubular arrangement.

According to another aspect, the yarn can be defined by two smaller yarns each having a different appearance and the appearance of the strips can be defined by the appearances of the smaller yarns.

According to another aspect, the repeat pattern in the yarn can be defined by portions of the yarn in which the smaller yarns are shielded from view by one another in alternating fashion. According to another aspect, the strip can be defined by two or more strip parts, the two or more strip parts each encircling the axis in a coiling manner and being offset from one another in the direction of the axis.

According to another aspect, the strip and strip parts each encircle the axis in a helical manner, the strip parts can have cross sections such that the strip parts are interlocked together throughout their lengths and the strip can be interlocked with itself throughout its length to define a flexible metal tube.

According to another aspect, the strip parts can overlap one another throughout their length and the strip overlaps itself throughout its length to define a flexible metal tube.

According to another aspect, the two or more strip parts can consist of two identical strip parts.

According to another aspect, the product can be selected from armour cable and flexible conduit.

A process for use with a product forms another aspect of the invention. The product is of the type having a metal strip encircling a central longitudinal axis in a coiling manner. The strip defines a tubular arrangement. The tubular arrangement has a groove defined by the edges of the strip. The process comprising the step of coiling a yarn about the tubular arrangement such that the yarn encircles the central longitudinal axis in a coiling manner and occupies the groove, thereby to produce a marked product.

According to another aspect, the yarn can be adapted and coiled such that, in the marked product, the appearance of the yarn changes in a repeat pattern along its length such that the yarn appears as strips of changing appearance arranged in a repeating pattern along the length of the tubular arrangement.

According to another aspect, one or more of the yarn and the tubular arrangement can have an adhesive; and the process can further comprise a heat treatment step wherein the adhesive is activated to secure the yarn to the tubular arrangement.

According to another aspect, the yarn can be defined by two smaller yarns each having a different appearance and the appearance of the strips is defined by the appearances of the smaller yarns. According to another aspect, the repeat pattern in the yarn can be defined by portions of the yarn in which the smaller yarns are shielded from view by one another in alternating fashion.

According to another aspect, the strip can be defined by two or more strip parts, the two or more strip parts each encircling the axis in a coiling manner and being offset from one another in the direction of the axis.

According to another aspect, the strip and strip parts can each encircle the axis in a helical manner, the strip parts can have cross sections such that the strip parts are interlocked together throughout their lengths and the strip can be interlocked with itself throughout its length to define a flexible metal tube. According to another aspect, the strip parts can overlap one another throughout their length and the strip can overlap itself throughout its length to define a flexible metal tube.

According to another aspect, the two or more strip parts can consist of two identical strip parts. According to another aspect, the product can be selected from armour cable and flexible conduit. The invention provides for a relatively economical and flexible system for durably marking armor cables and flexible conduits.

### BRIEF DESCRIPTION OF THE DRAWINGS

FIG. 1 is a schematic view showing an exemplary yarn being applied to an exemplary tubular arrangement according to an exemplary embodiment of the invention.

FIG. 2 is a photograph showing an exemplary embodiment of apparatus for carrying out the invention in use.

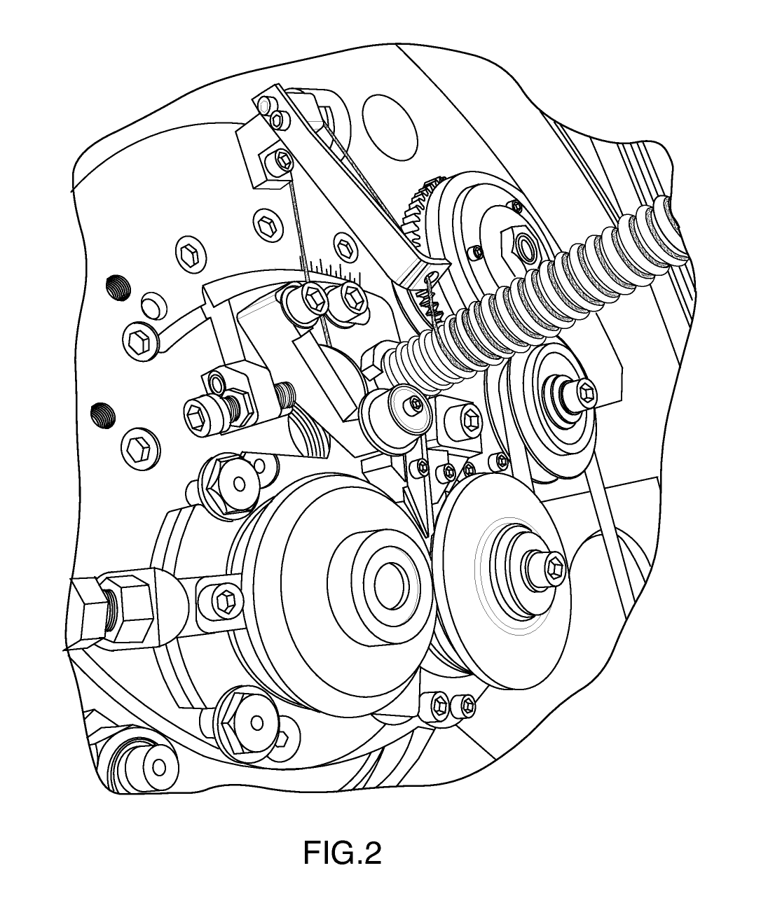

### DETAILED DESCRIPTION OF AN EXEMPLARY EMBODIMENT

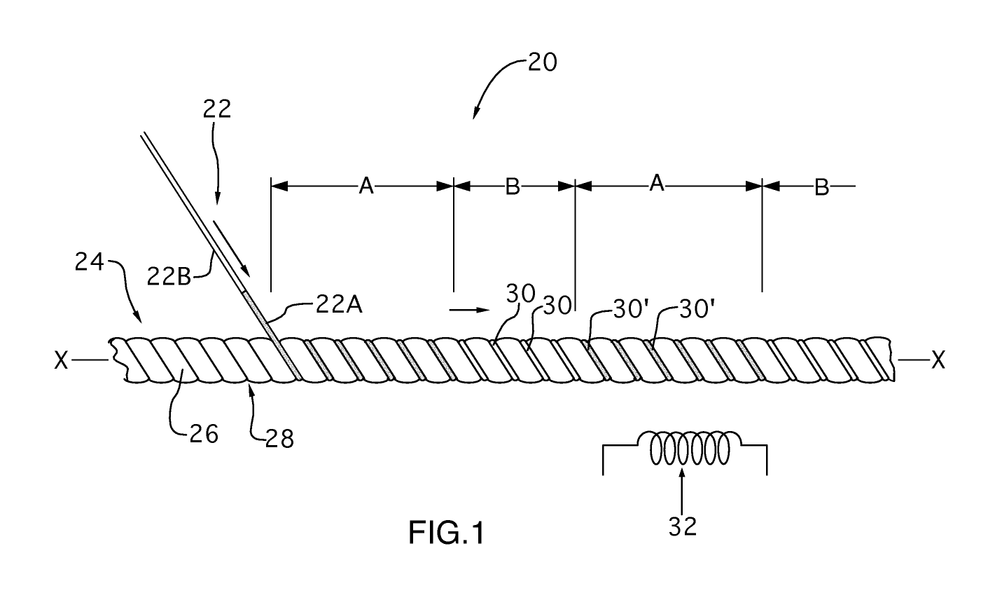

Reference is now made to FIG. 1 which, as indicated above, is a schematic view showing an exemplary yarn 22 being applied to an exemplary tubular arrangement 24 according to an exemplary embodiment of the invention.

Herein, a metal strip 26 will be seen encircle a central longitudinal axis X-X in a coiling manner, to define the tubular arrangement 24. The tubular arrangement 24 will be seen have a groove 28 defined by the edges of the strip 26.

In the resultant product 20, the yarn 22 will be seen to encircle the central longitudinal axis X-X in a coiling manner and to occupy the groove 28.

In the improved product, the appearance of the yarn 22 will be seen change in a repeat pattern along its length such that the yarn 22 appears as strips 30, 30′ of changing appearance arranged in a repeating pattern A-B along the length of the tubular arrangement 26.

Although not illustrated, it should be understood that the yarn 22 has applied thereto an adhesive. A suitable yarn/adhesive combination is arrived at by coating the yarn with a water based aliphastic/polyester polyurethane dispersion.

FIG. 1 is also illustrative of a heat treatment step of the process, wherein the assemblage is passed by a heater 32 which raises the temperature of the adhesive to between 88 C and 94 C, to activate the adhesive and secure the yarn to the tubular arrangement 26.

The yarn 22 is any synthetic or natural fibre strong enough to pass through the interlock armouring machine running at full production speed; the selection of such a fibre is a matter of routine to persons of ordinary skill in the art and accordingly further detail is neither provided nor required.

This yarn 22 is defined by two smaller yarns (not shown) each having a different appearance and the appearance of the strips 30,30′ is defined by the appearances of the smaller yarns; more particularly, the repeat pattern in the yarn can be defined by portions of the yarn 22A, 22B in which the smaller yarns are shielded from view by one another in alternating fashion. By way of further explanation, the yarn 22 will be seen in FIG. 1 to vary in appearance lengthwise, by virtue of alternating portions of light color 22B and dark color 22A. When wound upon the tubular arrangement, these portions 22A and 22B result in repeat units A and B, respectively.

The yarn is relatively durable, and provides a relatively permanent marking.

Conduits marked in this fashion are readily identifiable by conventional optical scanning techniques, thereby to permit, for example, inspectors to routinely identify cabling by smart phone app, using an image generated from the camera of the smart phone, which is also believed to be of significant advantage.

Whereas but a single embodiment is illustrated, variations are possible.

Foremost, in this regard, it will be appreciated that the yarn 22 can be obtained in any desired variation of portions 22A and 22B, thereby to permit very wide variations in the repeat pattern. For example, a yarn could be obtained with the following repeat patterns:

| | | | | | | |
|---|---|---|---|---|---|---|
| 1. | Dark | Light | Dark | Light | | |
| | 12″: | 6″: | 6″: | 6″ | | |
| 2. | Dark | Light | | | | |
| | 8″: | 6″ | | | | |
| 3. | Dark | Light | Dark | Light | Dark | Light |
| | 8: | 8″: | 16″: | 16″: | 8″: | 16″ |

which would result in 3 distinct markings.

As well, the yarn above can be obtained in multiple colors, thereby to permit even greater variations.

Of course, it will be appreciated that the relative length of the dark and light areas in the yarn will need to be varied to accommodate the girth of the conduit to be marked.

As yet another variation, whereas FIG. 1 shows a tubular conduit formed of a single strip part, the invention could be employed with any of the dual strip products described in U.S. Ser. No. 13/810,841, incorporated herein by reference.

Of course, the product can be selected from armour cable and flexible conduit.

Further, the process could be adapted for use with non-helically wound cables, in which case thread or tape could potentially be used in the place of the yarn.

Accordingly, the invention should be understood to be limited only by the accompanying claims, purposively construed.

1. An improved product, the product being of the type having a metal strip encircling a central longitudinal axis in a coiling manner, the strip defining a tubular arrangement, the tubular arrangement having a groove defined by the edges of the strip, wherein the improvement comprises:
a yarn secured to the tubular arrangement, encircling the central longitudinal axis in a coiling manner and occupying the groove.

2. A product according to claim 1, wherein, in the product, the appearance of the yarn changes in a repeat pattern along its length such that the yarn appears as strips of changing appearance arranged in a repeating pattern along the length of the tubular arrangement.

3. A product according to claim 1, wherein the yarn is adhesively secured to the tubular arrangement.

4. A product according to claim 1, wherein the yarn is defined by two smaller yarns each having a different appearance and the appearance of the strips is defined by the appearances of the smaller yarns.

5. A product according to claim 4, wherein the repeat pattern in the yarn is defined by portions of the yarn in which the smaller yarns are shielded from view by one another in alternating fashion.

6. A product according to claim 1, wherein the strip is defined by two or more strip parts, the two or more strip parts each encircling the axis in a coiling manner and being offset from one another in the direction of the axis.

7. A product according to claim 6, wherein the strip and strip parts each encircle the axis in a helical manner, the strip parts have cross sections such that the strip parts are interlocked together throughout their lengths and the strip is interlocked with itself throughout its length to define a flexible metal tube.

8. A product according to claim 6, wherein the strip parts overlap one another throughout their length and the strip overlaps itself throughout its length to define a flexible metal tube.

9. A product according to claim 6, wherein the two or more strip parts consist of two identical strip parts.

10. A product according to claim 1, wherein the product is selected from armour cable and flexible conduit.

11. A process for use with a product,
the product being of the type having a metal strip encircling a central longitudinal axis in a coiling manner, the strip defining a tubular arrangement, the tubular arrangement having a groove defined by the edges of the strip,
the process comprising the steps of:
coiling a yarn about the tubular arrangement such that the yarn encircles the central longitudinal axis in a coiling manner and occupies the groove,
thereby to produce a marked product.

12. A process according to claim 11, wherein the yarn is adapted and coiled such that, in the marked product, the appearance of the yarn changes in a repeat pattern along its length such that the yarn appears as strips of changing appearance arranged in a repeating pattern along the length of the tubular arrangement.

13. A process according to claim 11,
wherein one or more of the yarn and the tubular arrangement has an adhesive; and
further comprising a heat treatment step wherein the adhesive is activated to secure the yarn to the tubular arrangement.

14. A process according to claim 11, wherein the yarn is defined by two smaller yarns each having a different appearance and the appearance of the strips is defined by the appearances of the smaller yarns.

15. A process according to claim 14, wherein the repeat pattern in the yarn is defined by portions of the yarn in which the smaller yarns are shielded from view by one another in alternating fashion.

16. A process according to claim 11, wherein the strip is defined by two or more strip parts, the two or more strip parts each encircling the axis in a coiling manner and being offset from one another in the direction of the axis.

17. A process according to claim 16, wherein the strip and strip parts each encircle the axis in a helical manner, the strip parts have cross sections such that the strip parts are interlocked together throughout their lengths and the strip is interlocked with itself throughout its length to define a flexible metal tube.

18. A process according to claim 16, wherein the strip parts overlap one another throughout their length and the strip overlaps itself throughout its length to define a flexible metal tube.

19. A process according to claim 16, wherein the two or more strip parts consist of two identical strip parts.

20. A process according to claim 11, wherein the product is selected from armour cable and flexible conduit.
